(19) United States
(12) Patent Application Publication
(10) Pub. No.: US 2010/0189028 A1
(43) Pub. Date: Jul. 29, 2010

(54) METHOD AND SYSTEM FOR BROADCASTING DIGITAL SERVICES

(75) Inventor: Rogério Ferraz De Camargo, Sao Jose dos Campos-SP (BR)

Correspondence Address: BUCHANAN, INGERSOLL & ROONEY PC, POST OFFICE BOX 1404, ALEXANDRIA, VA, 22313-1404, US

(73) Assignee: ORBISAT DA AMAZONIA INDUSTRIA E AEROLEVANTAMENTO S/A, Manaus - AM (BR)

(21) Appl. No.: 12/666,446

(22) PCT Filed: Jul. 24, 2008
(86) PCT No.: PCT/BR2008/000217

§ 371 Date: Dec. 23, 2009

(30) Foreign Application Priority Data
Jul. 24, 2007 (BR) PI0706005-0

(51) Int. Cl. H04B 7/212; H04N 7/20; H04N 7/16

(52) U.S. Cl. 370/321; 725/68; 725/148

(57) ABSTRACT

Method and system for broadcasting digital services comprising a plurality of receiver sets located in several regions and at least one broadcasting facility which rebroadcasts several services with region-specific contents in a single transport stream (TS) consisting of time multiplexed digital packets, said TS reaching all the receiving sets in all the regions in the area covered by the signals originating from said broadcasting facility, the region-specific content being extracted from said TS by the receiving sets of each targeted region by filtering the packets containing region-specific and service-specific packet identifiers—PID's—which are periodically changed as a function of time in accordance with information contained in private tables which are also included in said TS.

### FIELD OF THE INVENTION

The present invention relates to digital radio, television and data broadcasting and receiving, either through satellite transmissions or ground stations.

### BACKGROUND OF THE INVENTION

Radio, television and data broadcasting according to known techniques do not allow the selection of receivers in specific regions, cities or quarters. It is a well-known fact that satellite broadcasts cover very large areas, encompassing whole countries or even continents, as shown in FIG. 1. In this figure it can be seen that the coverage of the Brazilian satellite broadcast signals, shown by the shaded portion of this figure, also comprises most of Uruguay, Paraguay, Bolivia end other neighboring countries.

Therefore, it may happen that some countries receive broadcasts whose content is not relevant or of interest to them. Moreover, even within each country, every region may have specific interests and needs that cannot be met by conventional satellite broadcasts. This happens more particularly with advertisements which are generally directed to specific geographic segments.

One way to get around this limitation consists in organizing networks of stations which are related to a main station which produces a generic program with interruptions that allow the insertion of specific material of local interest, such as advertising material. This is shown in FIG. 3, where the material broadcasted by an affiliated station is transmitted by a VHF or UHF earth station. In this case, the area coverage is automatically restricted by the limited reach of the broadcasted wave. FIG. 3 shows a situation in which the signal 100 generated by the master station is transmitted by a ground link, such as microwave route 101, to the affiliated station 102, where the regional content is inserted and the signal is rebroadcast by conventional VHF or UHF. The restriction of the receiving area 104 occurs naturally, due to the normal attenuation of the radiated VHF/UHF electromagnetic field, as well as by the earth curvature, as it is well-known that these frequency bands follow a line-of-sight propagation behavior.

In a general way, it is more convenient to transmit the local station program using a satellite, due to the fact that this kind of transmission is free from shadows or dead receiving areas. The arrival of satellites in geosynchronous orbits made available such transmissions in all regions of the Earth, including those isolated by natural obstacles as well as those with a low population density, where there would be no financial return in the outlay needed to install and operate conventional TV broadcasting stations.

Patent document US 2002060747 shows a digital broadcasting receiving device with an advertising information outputting function capable of receiving digital broadcasting and presenting local interest advertising information to a user, said device being shown in block diagram in FIG. 2. Said device comprises a satellite receiver 2 connected to a tuner and demultiplexer 3, which forwards the video and audio packets to a decoder 4, while sending service data to a CPU 5. Comprised within said data is the information that the broadcast material has entered the CM—commercial mode of operation.

Said CPU receives the geographical latitude and longitude data concerning the placement of the receiver, furnished by a GPS equipment coupled to antenna 6. As shown in the diagram, said CPU 5 is connected through a data bus to a memory 8 which stores advertising information. Therefore, when the CM mode is entered, CPU 5 communicates with said memory and extracts the advertising material specifically intended to the region defined by the geographic placement of said receiver. Memory 8 can be downloaded with advertising material broadcast from a satellite in a preset time schedule or in a sub-channel or service channel Considering that a satellite broadcast covers a wide area, such a whole country or even several countries, said advertising material must be associated with geographical data, such as a polygon defining the target area for each advertising message. Moreover, each advertising message may be associated with the exhibition times, number of exhibitions and so on. Therefore, when communicating with said memory 8, said CPU 5 will check which advertising messages are targeted to the specific area in which the receiver is placed, as well as the proper time for showing said messages. The message data is then forwarded to decoder 4, which generates analog video and audio signals which are processed by amplifiers 9 and 10 and viewed by means of monitor 11 and heard through loudspeakers 12.

Such a system requires a large capacity memory for storing the mass of advertising data, most of which is not relevant to the region in which the receiver is placed. Moreover, the transmission of the advertising information during the rest period of the master station requires that the receiver be kept operating, in order to enable the reception, storage in memory 8 of the new information, as well as deleting the old advertisement information.

As commented before, another way of achieving said area limitation would be to rebroadcast the signals by VHF/UHF ground transmissions, which raises some technical and administrative problems, such as the limited number of available frequency channels.

### OBJECTS OF THE INVENTION

In view of the above, the present invention has the main object of providing services such as TV, radio or even data programs, rebroadcast by ground stations or satellites, with can be received in previously specified regions.

Another object of the invention is to avoid the use of high capacity memories for storing the advertising material.

Another object of the invention is to insure that program material intended for a specific region will not be used by other regions.

A further object of the invention is to provide a system in which said specific region reception can be applied to open TV, radio or data broadcasts, so that subscription by the interested parties will not be needed.

Finally, an object of the instant invention is to make available to digital radio and TV open broadcasters or autonomous stations, operating via satellite or through ground stations, a technique in which the content is transmitted without any cryptographic processing, at the same time that enables the service provider to select the geographic region in which its clients are situated.

These objects will be better understood by comparing FIGS. 3 and 4. The first sows a known system in which the master station 100 transmits, via a microwave link 101, a generic content that is received by affiliated station 102. In the latter, a specific content is added to the generic program, so as to create a service or program which is broadcast in VHF or UHF by transmitter 103 to a region 104, using an available frequency radio-frequency channel. Therefore, all sets in region 104 will receive the same program content.

The instant system is designed to provide the situation shown in FIG. 4. In this figure, station 102 can be either part of a network or an independent station. As shown in FIG. 4, station 102 transmits to a satellite 105 a signal that comprises a plurality of specific programs, resulting from combining a generic program received from the master station with local interest contents. All of said specific programs are rebroadcast to a wide area that comprises regions 110, 111, 112 and 113. According to the system and method hereby presented, the receiving sets in each of said regions will receive the specific programs specific for each region, while excluding the remaining ones. Among other advantageous features, the instant system and method allows the insertion of region-specific advertising messages, which can be updated in real time.

### SUMMARY OF THE INVENTION

The above mentioned objects are provided by the invention by means of a method and system in which several region-specific contents are transmitted by a broadcasting facility in digital packets contained in a single transport stream (TS) which is common to all said services, said TS reaching all the receiving sets in all the regions comprised in the area covered by the signals originating from said broadcasting facility, the region-specific content being extracted from said TS by the receiving sets of each targeted region, said extraction being enabled by the fact that each packet carries information specifically identifying each service and each region to which it is directed.

According to another feature of the invention, the correlation between each service and the packet identifier is contained in private tables which are also contained in said TS, said tables being periodically updated.

According to another feature of the invention, said TS is generated in a station that may or may not be affiliated to a network.

According to yet another feature of the invention, said TS may be transported by the signals originated by a broadcasting facility, such as a terrestrial VHF/UHF transmission, a satellite transmission or a cable distribution system.

According to one more another feature of the invention, said TS is produced by the time multiplexing of said services with region-specific contents, said multiplexing being associated with the identification of each packet by means of a corresponding PID—packet identifiers.

According to yet another feature of the invention, the region-specific programs may be produced by adding the region-specific content to a generic content which is common to all regions, when this generic content exists, such as is the case with stations affiliated to a network.

According to still another feature of the invention, the region-specific content may comprise advertising materials or local or regional information.

According to another feature of the invention, said private tables comprise two kinds of table, the first kind, hereafter named as a “Type 1” table, containing the geographical coordinates that define the polygon encompassing each region, and informing, for each region, the PID of a second kind of table, hereafter referred to as a “Type 2” table, the contents of which are synchronously changed in step with the changes in the packet identifiers related to each specific service and each region.

According to another feature of the invention, the content transporting portion of each packet as well as the PID containing portion are transmitted without any cryptographic processing.

According to another feature of the invention, each receiver set is provided with a GPS device which provides the identification of the region in which it is placed.

According to another feature of the invention, said tables are private tables added to the transport stream.

In the instant system and method, considering that the services' PIDs are periodically changed, the receiving set must access the corresponding tables in order to be able to extract the packets containing data related to said services. Said tables are contained in specific places associated with the respective regions, which are informed by said first table whose address is known and may be stored in the set either when it is installed, or received through any communications channel or even included in non-private tables defined in several digital transmission standards, such as DVB, ATSC, and so on.

Therefore, notwithstanding the fact that the content is transmitted in an open format, without any cryptographic processing, conventional receivers will not be able to exhibit the programs, due to the fact that they won't have access to the dynamically updated tables. Nevertheless, receiving sets built according to the present technique will have free access to services that are not transmitted according to the instant invention, i.e, conventional broadcast services.

According to another feature of the invention, said proprietary tables are generated by a Tables and PIDs Managing device, set up in broadcast station 102, said device also performing the dynamic updating of the PID's.

According to another feature of the invention, the timing between successive PIDs' updating is defined by station 102.

According to another feature of the invention, receiver sets detect and identify said proprietary tables and derive from them the updated PIDs. According to another feature of the invention, the coverage of each station 102 may comprise several polygons defining specific regions, each polygon being identified by a set of geographical coordinates.

### BRIEF DESCRIPTION OF THE DRAWINGS

The foregoing and other objects, features, aspects and advantages of the present invention will become more apparent from the following detailed description of the present invention when taken in conjunction with the appended to drawings.

FIG. 1 exemplifies the coverage of a stationary satellite.

FIG. 2 shows the block diagram of a state of the art receiver set, such as the one described in US 2002060747.

FIG. 3 exemplifies the region coverage provided by previous known techniques.

FIG. 4 shows the region-specific coverage provided by the present invention.

FIG. 5 shows the section of the transmitting equipment related to the present invention.

FIG. 6 is a more detailed depiction of the PID Manager.

FIG. 7 shows an example of a Type 1 table, which correlates the set of geographical coordinates that defines a polygon with a specific coverage region.

FIG. 8 exemplifies a Type 2 table, which shows the dynamically updated PIDs in a specific coverage region as a function of time.

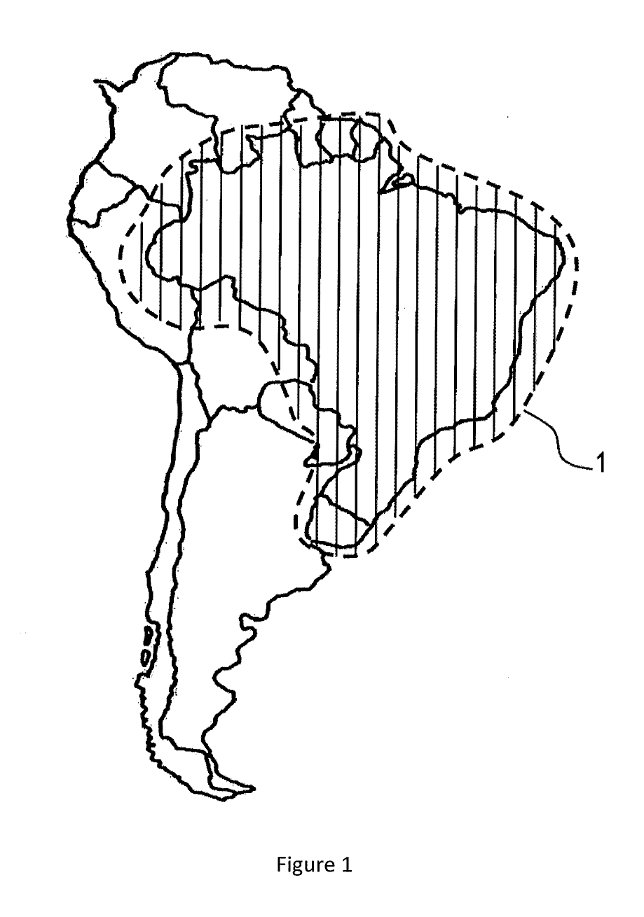

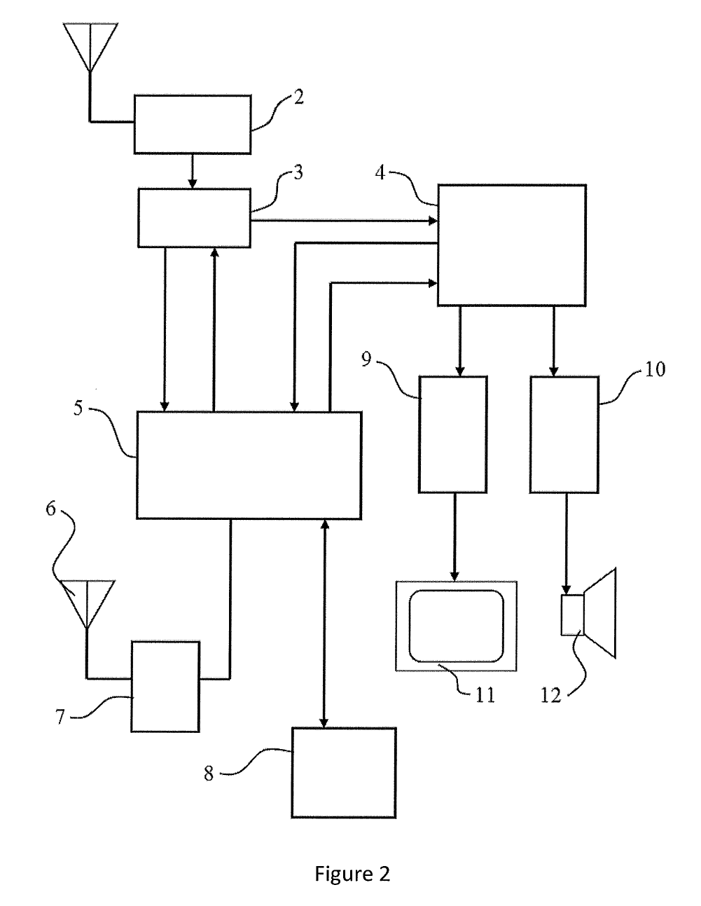

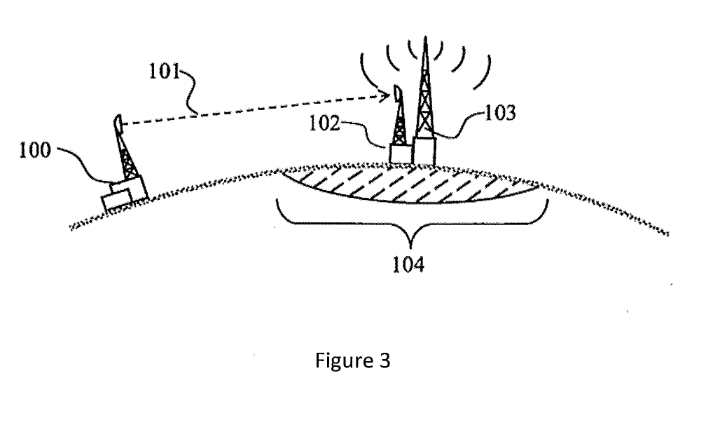

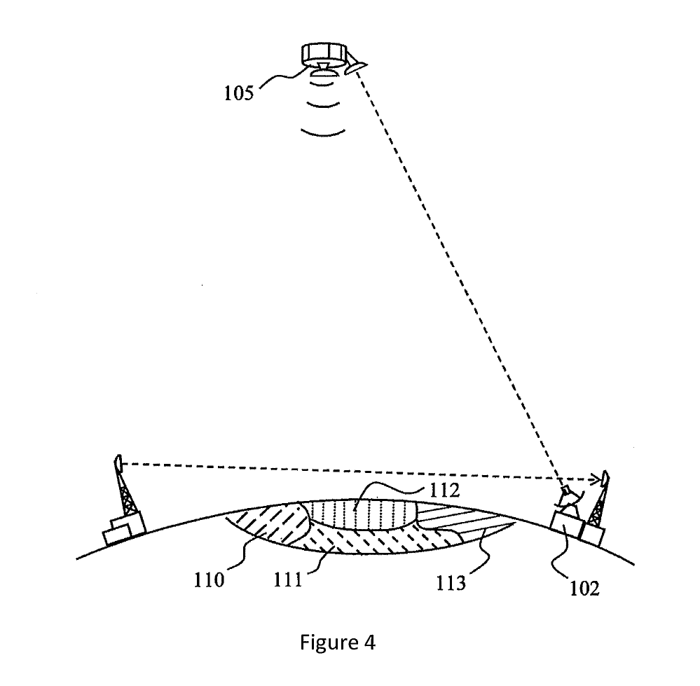

### DETAILED DESCRIPTION OF A PREFERRED EMBODIMENT

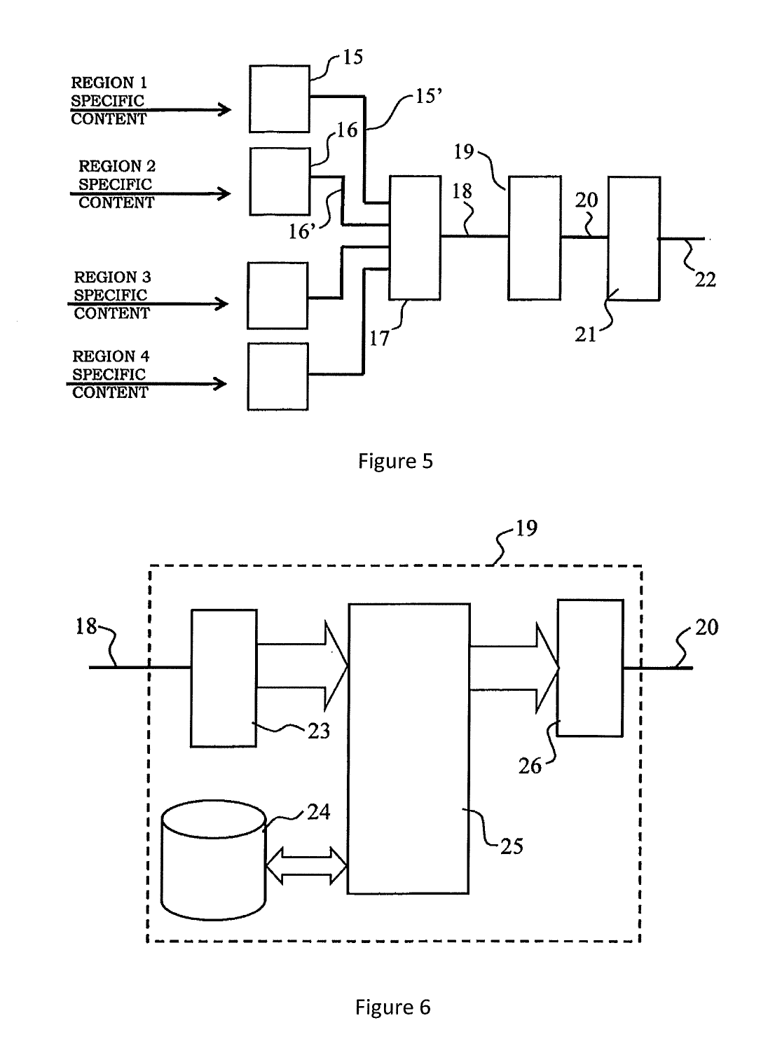

An embodiment of the present invention will be described on the basis of FIG. 5 and FIG. 6. According to said figures, the transmitting setup comprises a plurality of encoders 15, 16 and so on, each one receiving the content of a service to be broadcast to a specific region. When the service is a TV program, said content comprises the video signal, the audio signal, tele-text, and so on. Each encoder generates a packet sequence using a known standard such as MPEG-2, H.264, and so on, at a specific bit-rate. Therefore, at the output of encoder 15 there will issue a packet sequence 15′ that is to be transmitted to region “1”. Encoder 16 produces a packet sequence 16′ that is to be transmitted to region “2”, and so forth.

Each packet of sequences 15′, 16′, and so on is identified by a specific PID—packet identifier—according to the encoding standard. The encoded signals are then inputted to multiplexer 17, which will time-multiplex said sequences so as to generate a TS—transport stream—with a higher bit-rate, in order to incorporate the packets of all the services provided by said encoders. According to the principles of the invention, the TS bit-rate will be higher than the one needed to incorporate all of said service packets, in order to allow the introduction of null packets in said TS. In conventional known systems, null packets are used only to keep an unchanging bit-rate at the multiplexer 17 output, so as to enable the receiver to be synchronized with the transmitter.

At the output of multiplexer 17, the preamble of each packet comprises a PID that allows the receiver to identify the service to which said packet belongs. These identifiers are listed in a PMT—Program Map Table—which is automatically generated by multiplexer 17 when inserting the PID's referring to each service. It should be noted that one service may be associated with more than one PID, such being the case with TV transmissions, in which there is a video PID, an audio PID, and so on.

Therefore, when a set is tuned to receive e specific program, it creates a “filter” which allows the entrance and processing of the packets identified by the PID or PIDs associated to the intended service. Said packets are forwarded to a buffer where the service content is reassembled so as to allow for its reproduction. In conventional systems, the PID's remain unchanged, so the filter is only reconfigured when the set is tuned to a different service, there being no restriction of access of the set to all services. In the present invention, however, the original PID's of the packets that constitute the transport stream are periodically changed in a randomized way, when this stream is inputted to the PID and Tables Manager 19.

Said Manager 19 may or may not be included in a PC computer and it performs a rearrangement of the services' PIDs with a predefined periodicity, such as, for instance, between 2 and 10 times per second; the interval between changes may be defined by the service provider. It must be remarked that said rearrangement does not change the services' content nor the multiplexer-generated tables, such as the PMT. Synchronously with each rearrangement, Manager 19 generates private Type 2 tables which show the updated relationship between the PIDs and the packets, said tables being inserted in the null packets of the TS. After this processing the stream is forwarded through line 20 to a conventional modulator 21 and to the RF transmitter.

FIG. 6 shows in simplified form the elements that provide the dynamic PID rearrangement when the PID and Tables Manager is part of PC computer. In this block diagram, first board 23 changes the ASI-standard of the signal received through line 18 into a signal that can be handled by processor 25. This processor employs the software stored in memory 24, dynamically changing the PID's and generating the corresponding private tables. Conversion board 26 changes the processed signal back into ASI standard and forwards said signal to the modulator through line 20.

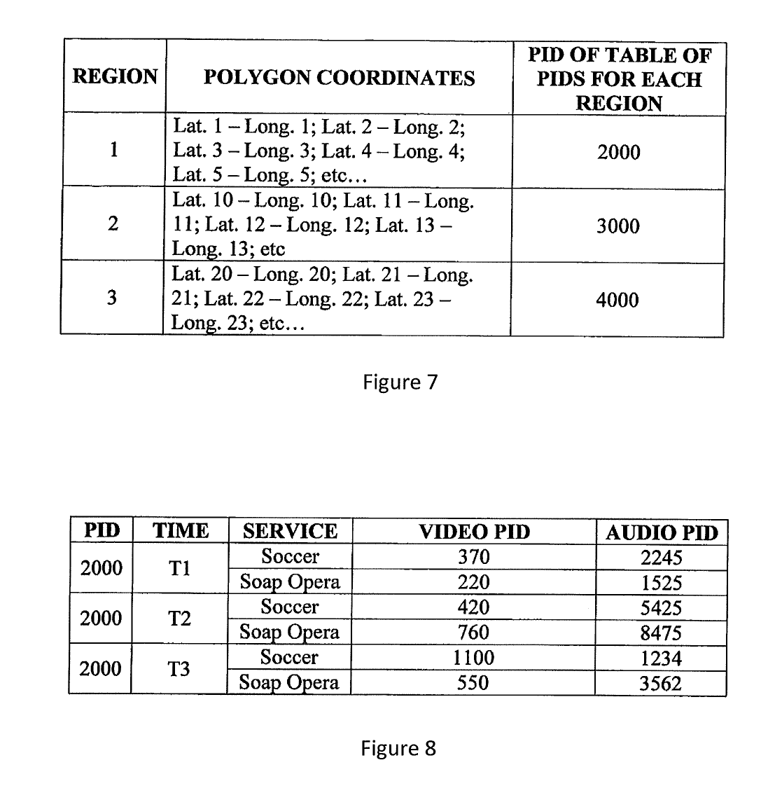

As mentioned before, private tables inserted into the null packets are of two kinds. The first defines each region of coverage by means of a polygon formed by geographical coordinates. Such a table is shown in FIG. 7, where it can be seen that it furnishes the PID of the table of PIDs for each region. So, PID 2000 is the address in which the region “1” dynamically updated table (Type 2 table) can be found; PID 3000 is the address which will be accessed by the equipment to retrieve the dynamically modified table (Type 2 table) for region “2”, and so forth. As mentioned, a Type 2 table correlates the region-specific programs with their PIDs at each moment during the transmission, and is dynamically updated.

FIG. 8 depicts in a simplified way a Type 2 table and its updating. Let us consider that for a specific region, such as region “1”, associated with PID 2000, there are available two services (i.e., two TV programs), named “Soccer” and “Soap Opera”. At moment T1, the “Soccer” video PID is 370 and the “Soap Opera” video PID is 220, the audio PID's being, respectively, 2245 and 1525. On moment T2, for instance 0.1 second later, the PID that identifies the “Soccer” video packets has been changed to 420, and the audio packets are to be retrieved from PID 5425. Another 0.1 second later the video and audio “Soccer” PID's are changed to 1100 and 1234, while the video and audio packets for “Soap Opera” are identified by PID's 550 and 3562.

A conventional receiver will not be able to reconstruct the content of these services, because it does not have the information relate to the PID updating, due to the fact that such information is listed in private tables, in accordance with the principles of the invention. Even considering the case that at a random moment the receiver tunes to PID 420 at moment T2, it will stop receiving the video packets for “Soccer” after 0.1 second (moment T3), due to the fact that the PID has been dynamically changed to 1100, and the conventional receiver has no way of knowing what is the new PID. Only the receivers built according with the invention will be able to do this, as will be explained below.

A receiver built according to the invention is provided with a GPS device, which ascertains the geographical coordinates of its placement. Moreover, the receiver “knows” the PID of the Type 1 table—which may be stored in its non-volatile memory. Cyclically the receiver accesses said Type 1 table employing the stored PID and, by cross-checking its geographic location—given by the GPS device—with the data stored in said Type 1 table, finds out the PID corresponding to the Type 2 table. Using the data contained in the latter, which is dynamically updated during the transmission process, the receiver dynamically reconfigures the packet-receiving filters in order to process at every moment only the packets containing the desired service, i.e., the packets identified by the PID's specified in the Type 2 table. In an advantageous embodiment of the invention, the new PID's may be informed to the receiver a few milliseconds before coming into effect. This will give the receiver enough time to reconfigure its filters, which should be in their new adjustment at the time of arrival of the packets with the new PID's. During the short time in which said reconfiguration is carried out, the process will not be noticed by the user.

It can be seen that a set placed in a specific region will not be able to receive any services intended for other regions, because its geographical coordinates do not allow the access to the Type 2 table for other regions. Private Type 1 tables, such as the one shown in FIG. 7, may remain unchanged or be updated at longer time intervals than Type 2 tables.

Conventional digital receiving sets will not be able to receive the content of the services broadcast according to the invention, because they do not know the formatting of the private tables that inform the packet's PID's. However, sets constructed according to the invention will continue to receive conventional transmissions, due to the fact that, after detecting the absence of private tables, these receivers will search for the PID's of the services provided in the tables corresponding to the transmission standard, such as a PMT table.

Although the present invention has been described and illustrated in detail, it is clearly understood that the same is by way of illustration and example only and is not to be taken by way of limitation, the spirit and scope of the present invention being limited only by the terms of the appended claims.

1. Method for broadcasting digital services in which several services with region-specific contents are broadcast, wherein said region-specific contents are transmitted by a broadcasting facility in time multiplexed digital packets contained in a single transport stream (TS) which is common to all said services and all regions, said TS reaching all the receiving sets in all the regions comprised in the area covered by the signals originating from said broadcasting facility, the region-specific content being extracted from said TS by the receiving sets of each targeted region by filtering the packets containing region-specific and service-specific packet identifiers—PID's—which are periodically changed as a function of time in accordance with information contained in private tables which are also included in said TS.

2. Method for broadcasting digital services as claimed in claim 1, wherein the information stored in a non-volatile memory of the receiving set enables the location of said private tables within the TS, said location comprising a first and a second steps, respectively corresponding to tables of a first kind and tables of a second kind.

3. Method for broadcasting digital services as claimed in claim 2, wherein said tables of the first kind furnish the address of the tables of the second kind contained in the TS based on the geographical coordinates of the placement of the receiving set.

4. Method for broadcasting digital services as claimed in claim 3, wherein said geographical coordinates are furnished by a GPS device contained in said receiving set.

5. Method for broadcasting digital services as claimed in claim 1, wherein the contents targeted to a specific region are obtained by incorporating region-specific contents to a generic program received from a master station.

6. Method for broadcasting digital services as claimed in claim 5, wherein said region-specific contents comprise advertising materials.

7. Method for broadcasting digital services as claimed in claim 5, wherein said region-specific contents comprise information of local interest.

8. Method for broadcasting digital services as claimed in claim 1, wherein said periodic changes in the packet PID's comprise the dynamic changes in the service PID's, each said change in the service PID being simultaneously inserted in private tables of the second kind, correlating each service with the corresponding PID.

9. Method for broadcasting digital services as claimed in claim 8, wherein it uses a single private table of the first kind which furnishes, for each region as defined by a polygon of geographical coordinates, the PID of the corresponding table of the second kind.

10. Method for broadcasting digital services as claimed in claim 9, wherein a PID known by all receivers is used to access said table of the first kind.

11. Method for broadcasting digital services as claimed in claim 10, wherein each receiver finds out the region to which it belongs by entering the geographical coordinates of its placement into said table of the first kind.

12. Method for broadcasting digital services as claimed in claim 11, wherein the PID of the table of the second kind is found out by inputting, into the table of the first kind, the information concerning the region in which the receiver set is placed.

13. Method for broadcasting digital services as claimed in claim 12, wherein the content-carrying packets, comprising video, audio and data information corresponding to a specific service are extracted from the TS received by the receiver set by filters configured according to the PID's furnished by the corresponding table of the second kind.

14. Method for broadcasting digital services as claimed in claim 13, wherein said filters are dynamically updated with the PID's furnished by the table of the second kind, said PID's being periodically changed at the broadcasting facility.

15. Method for broadcasting digital services as claimed in claim 1, wherein said broadcasting facility comprises a satellite broadcasting system.

16. Method for broadcasting digital services as claimed in claim 1, wherein said broadcasting facility comprises a terrestrial broadcasting system.

17. Method for broadcasting digital services as claimed in claim 1, wherein said broadcasting facility comprises a cable distribution system.

18. System for broadcasting digital services, wherein it comprises a radio, television or data broadcasting facility which generates and broadcasts region-specific services, said services being processed by the method described in claim 1.

19. System for broadcasting digital services as claimed in claim 18, wherein said broadcasting facility is a station affiliated to a radio, television or other services network, said station rebroadcasting a content which is obtained by combining region-specific content with a content generated by a master station.

20. System for broadcasting digital services as claimed in claim 19, wherein said rebroadcasting is performed by a satellite.

21. System for broadcasting digital services as claimed in claim 19, wherein said rebroadcasting is performed by a terrestrial broadcast station.

22. System for broadcasting digital services as claimed in claim 19, wherein said rebroadcasting is performed by a cable distribution system.

23. System for broadcasting digital services as claimed in claim 18, wherein it comprises a plurality of receiver sets, each on of which is provided with a GPS device which furnishes the geographical coordinates of its placement.
